(19) United States
(12) Patent Application Publication
(10) Pub. No.: US 2023/0324857 A1
(43) Pub. Date: Oct. 12, 2023

(54) AUTOMATION DEVICE, PROCESS VALVE ASSEMBLY AND METHOD

(71) Applicant: Festo SE & Co. KG, Esslingen (DE)

(72) Inventors: Matthias JOACHIMSTHALER, Karlsruhe (DE); Rainer NITSCHE, Kirchheim (DE)

(21) Appl. No.: 18/297,980

(22) Filed: Apr. 10, 2023

(30) Foreign Application Priority Data
Apr. 12, 2022 (DE) 10 2022 108 940.1

(51) Int. Cl. G05B 13/04

(52) U.S. Cl. CPC G05B 13/042

(57) ABSTRACT

An automation device for industrial automation, for closed-loop controlling and/or diagnosing a pneumatic actuator with an actuator member. The automation device has a model, in particular a non-linear model, of the pneumatic actuator, which has at least one model parameter by means of which the model can be adapted to different variants of the pneumatic actuator, and wherein the automation device is configured to carry out closed-loop control and/or diagnosis of the pneumatic actuator using the model.

This application claims priority to German application 10 2022 108 940.1, filed Apr. 12, 2022, which is incorporated by reference.

### SUMMARY OF THE INVENTION

The invention relates to an automation device for process automation, for closed-loop controlling and/or diagnosing a pneumatic actuator with an actuator member.

The automation device is, for example, a closed-loop controller and/or diagnostic device for a process valve. For example, the automation device is a positioner. The pneumatic actuator is in particular a process valve. The process valve comprises, for example, a drive and a fitting that can be actuated by the drive.

The pneumatic actuator can be present in one of several possible variants. The variants may differ, for example, in their kinematics. For example, there is at least one linear variant with a piston and/or a linear variant with a diaphragm and/or a rotational variant with a rack and pinion gear and/or a rotational variant with a scotch yoke. Furthermore, the variants may differ in their dimensioning, in particular their size. For example, there is at least one variant in a first size and/or a second variant in a second size different from the first size. Furthermore, the variants may differ in their loads. The load is determined, for example, by the fitting and/or a process medium to be influenced by the process valve.

There is the approach to use a PID controller for the closed-loop control of a pneumatic actuator. A PID controller can usually be implemented easily and has a small number of parameters to be set. However, since a pneumatic actuator usually has strong nonlinearities (due to compressible air), a PID controller typically cannot achieve optimal closed-loop control quality when closed-loop controlling a pneumatic actuator. This also applies in particular to the case where there are different variants of the pneumatic actuator and the PID controller is to be used for the different variants.

It is an object of the invention to provide a flexibly usable automation device with which an easy-to-implement and accurate closed-loop control and/or diagnosis of the pneumatic actuator is possible.

The object is solved by an automation device according to claim 1. The automation device has a model, in particular a non-linear model, of the pneumatic actuator. The model has at least one model parameter via which the model can be adapted to different variants of the pneumatic actuator. The automation device is configured to perform closed-loop control and/or diagnosis of the pneumatic actuator using the model.

The use of a non-linear model in particular enables precise closed-loop control and/or diagnosis of the pneumatic actuator. The fact that the model can be adapted to different variants of the pneumatic actuator via the at least one model parameter means that the automation device can be used with the different variants of the pneumatic actuator and can therefore be used flexibly.

The model can also be referred to as a generalized model. Expediently, all variants of the pneumatic actuator, in particular all sizes and kinematics of the pneumatic actuator, can be described with the model. Expediently, the model has a reduced number of adjustable model parameters (compared to conventional models), for example a maximum of four or exactly four adjustable model parameters, or a maximum of five or exactly five adjustable model parameters.

The model is adapted to the present pneumatic actuator via the one or more model parameters. The pneumatic actuator that is to be closed-loop controlled and/or diagnosed with the automation device, i.e. in particular the pneumatic actuator that is connected to the automation device, is referred to as the present pneumatic actuator. The respective variant of the present pneumatic actuator shall also be referred to as the present variant.

Advantageous further developments are the subject of the subclaims.

The invention further relates to a process valve assembly comprising the automation device and the pneumatic actuator, wherein the pneumatic actuator is designed as a process valve.

The invention further relates to a method for operating the automation device or a process valve assembly, comprising the step of: performing closed-loop control and/or diagnostics of the pneumatic actuator using the model.

Preferably, the method is further embodied in correspondence to an embodiment of the automation device or the process valve assembly explained above and/or below.

The invention further relates to a method for operating a system comprising a plurality of arrangements, each comprising a respective automation device and a respective pneumatic actuator associated with the respective automation device, wherein each automation device is implemented according to the aforementioned automation device and has a respective model for performing diagnosis and/or control of the respective associated pneumatic actuator, wherein the models of the automation devices do not differ from each other, and wherein at least two of the pneumatic actuators differ from each other in their variant, the method comprising the step of: adapting at least one model parameter of each model in order to adapt the respective model to a present variant of the respectively associated pneumatic actuator.

Preferably, the method is further embodied in correspondence to an embodiment of the automation device or the process valve assembly explained above and/or below.

### BRIEF DESCRIPTION OF DRAWINGS

Further exemplary details as well as exemplary embodiments are explained below with reference to the figures. Thereby shows

FIG. 1 a schematic representation of an arrangement with an automation device and a single-acting pneumatic actuator,

FIG. 2 a schematic representation of a double-acting pneumatic actuator,

FIG. 3 a flowchart of a parameter adjustment procedure.

FIG. 4 a block diagram of a closed-loop control and/or diagnosis performed with the automation device,

FIG. 5 a schematic representation of a process valve assembly with an automation device and a single-acting pneumatic actuator,

FIG. 6 a double-acting pneumatic actuator, and

FIG. 7 a system with multiple arrangements.

### DETAILED DESCRIPTION OF THE INVENTION

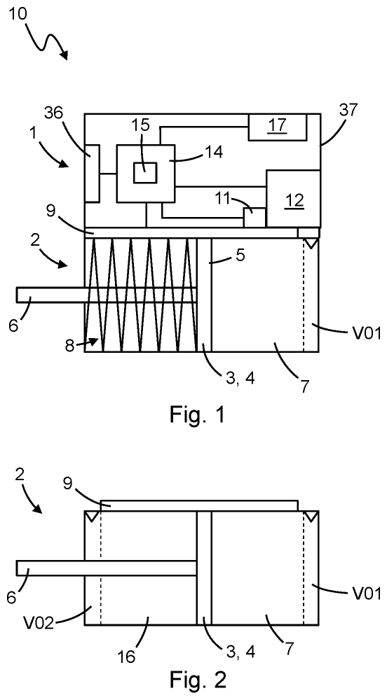

FIG. 1 shows an arrangement 10 comprising an automation device 1 and a pneumatic actuator 2. The arrangement 10 represents an exemplary application environment for the automation device 1. The automation device 1 can also be provided on its own—i.e. in particular without the pneumatic actuator 2.

The automation device 1 is designed for use in industrial automation, in particular in process automation. The automation device 1 is designed to closed-loop control and/or diagnose the pneumatic actuator 2.

The pneumatic actuator 2 has an actuator member 3. Purely by way of example, the pneumatic actuator 2 is designed as a drive cylinder. The pneumatic actuator 2 has a piston arrangement 4, which expediently comprises a piston 5 and preferably a piston rod 6 coupled to the piston 5. Exemplarily, the piston arrangement 4 forms the actuator member 3. The pneumatic actuator 2 has a first pressure chamber 7. The first pressure chamber 7 is delimited by the piston arrangement 4. By applying compressed air to the first pressure chamber 7, the position of the actuator member 3 can be changed.

Purely by way of example, the pneumatic actuator 2 is designed as a single-acting actuator. The single-acting actuator 2 comprises a spring element 8 that provides a spring force acting on the piston arrangement 4. When the first pressure chamber 7 is not aerated, the spring force causes the piston arrangement 4 to move to a first end position. The first end position is exemplarily a retracted end position of the piston arrangement 4. If the first pressure chamber 7 is aerated, the piston arrangement 4 is moved to a second end position (against the spring force) by the pressure present in the first pressure chamber 7. The second end position is, by way of example, an extended end position.

Exemplarily, the arrangement 10 has a position sensor device 9, which is exemplarily arranged on the pneumatic actuator 2. The position sensor device 9 serves to detect the current position of the actuator member 3. Expediently, the current position of the actuator member 3 can be detected by means of the position sensor device 9 over the entire movement path of the actuator member 3—i.e. from the first end position to the second end position. The position sensor device 9 provides a position signal that represents the current position of the actuator member 3.

Exemplarily, the arrangement 10 has a pressure sensor device 11, which is expediently part of the automation device 1. The pressure sensor device 11 serves to detect the current pressure of the first pressure chamber 7. This current pressure of the first pressure chamber 7 shall also be referred to as the current first pressure. The pressure sensor device 11 provides a first pressure signal which represents the current first pressure of the first pressure chamber 7.

Purely by way of example, the automation device 1 has a valve device 12, by means of which the automation device 1 can aerate and/or de-aerate the first pressure chamber 7. The valve device 12 is designed, for example, as an I/P converter—i.e. as a current/pressure converter.

Optionally, the automation device 1 has an input unit 17 by means of which a user can make an input to the automation device 1.

Preferably, the automation device 1 has a control unit 14, which is designed as a microcontroller, for example, which includes a processor having software, program, code, or program instructions that cause the operations, functions, or actions discussed herein.

The control unit 14 expediently receives the first pressure signal and/or the position signal. Preferably, the control unit 14 controls the valve device 12.

Optionally, the automation device 1 has a communication interface 36, which is used in particular for communication with a higher-level controller, for example, to receive a setpoint, in particular for closed-loop controlling the position of the actuator member 3.

As already explained at the beginning, the pneumatic actuator 2 can be realized in one of several possible variants. The variants differ, for example, in their kinematics, their dimensioning and/or their load.

The automation device 1 has a model 15 of the pneumatic actuator 2. The model 15 is in particular a non-linear model of the pneumatic actuator 2. The model 15 has at least one model parameter via which the model can be adapted to different variants of the pneumatic actuator 2. The model 15 is expediently stored in the control unit 14, in particular in a non-volatile memory. The automation device 1 is configured to perform closed-loop control and/or diagnosis of the pneumatic actuator 2 using the model 15.

Expediently, the model 15 comprises a first model designed in particular for the closed-loop control and/or diagnosis of a single-acting pneumatic actuator 2.

Purely by way of example, the model 15, in particular the first model, defines the relationships described below by equations (1), (2) and/or (3). Preferably, the model 15 comprises the equations (1), (2) and/or (3), and/or is based on the equation (1), (2) and/or (3):

$${\dot{x}}_{1} = \dot{x} = {x}_{2} \qquad ( 1 )$$

$${\dot{x}}_{2} = \ddot{x} = a [ ( {p}_{1} - {p}_{u} ) - F ( {x}_{1} - {x}_{F} ) ] \qquad ( 2 )$$

$${\dot{x}}_{3} = {\dot{p}}_{1} = \frac{κ}{{V}_{01} + Δ {Vx}_{1}} ( {RTu}_{1} ( t ) - Δ {Vx}_{2} {p}_{1} ) \qquad ( 3 )$$

x is the current position of the actuator member 3. x is equal to x₁. Exemplary x has the unit %. x₂ is the time derivative of x.

a is preferably equal to 1 and has exemplarily the unit % m/kg. a shall also be referred to as the pressure term coefficient, in particular the first pressure term coefficient.

p₁ is the current first pressure in the first pressure chamber 7 and has expediently the unit

$$\frac{kg}{{s}^{2} m} .$$

pᵤ is the ambient pressure of the pneumatic actuator 2 and, expediently, has the unit

$$\frac{kg}{{s}^{2} m} .$$

For example pᵤ is the atmospheric pressure.

F is an adjustable model parameter and shall be referred to as the position term coefficient. The unit of F is expediently

$$\frac{kg}{{s}^{2} \% m} .$$

x_{F} is an adjustable model parameter and shall be referred to as the spring bias travel parameter. The unit of x_{F} is expediently %. The spring bias travel parameter may also be referred to as spring preload travel parameter.

K is the isentropic exponent especially of air.

V₀₁ is an adjustable model parameter and shall be referred to as the first dead volume parameter. The unit of V₀₁ is expediently m³.

ΔV is an adjustable model parameter and shall be referred to as the volume change rate parameter. The unit of ΔV is expediently

$$\frac{{m}^{3}}{\%} .$$

R is the general gas constant.

T is the temperature.

u₁ (t) shall also be referred to as the first aeration variable and is, by way of example, the current first mass flow of compressed air into or out of the first pressure chamber 7. Expediently, the automation device 1 calculates the first aeration variable on the basis of a pressure detected (in particular with the pressure sensor device 11), a position detected and/or on the basis of a control of the valve device 12.

The following explanations in particular relate to the first model.

Exemplarily, the model 15, in particular the first model, comprises a first state variable x₁, a second state variable x₂ and/or a third state variable x₃.

Expediently, the model 15, in particular the first model, comprises as a state variable, in particular as the first state variable x₁, the current position x of the actuator member 3. The current position x of the actuator member 3 is expediently measured by the position sensor device 9. In particular x is represented by the current signal value of the position signal. The current position x—and thus the first state variable x₁—is preferably defined as a relative quantity in the model 15. This means in particular that the current position x is defined, in the model 15, as a ratio to a maximum position—i.e. in particular an end position—and/or a maximum travel distance of the actuator member 3. For example, in the model 15, a current position with the position value 0 corresponds to the first end position of the actuator member 3 and/or a current position with the position value 1 corresponds to the second end position of the actuator member 3. Optionally, the current position x is defined as a percentage in the model 15. In particular, the current position x in the model 15 has no physical unit, in particular no physical length unit and/or no angle unit. Preferably, the position x in the model 15 is a dimensionless quantity.

\dot{x}₁ is the time derivative of the first state variable x₁, \dot{x} is the time derivative of the current position x.

Expediently, the model 15, in particular the first model, comprises as a state variable, in particular as a second state variable x₂, the current velocity of the actuator member 3—i.e. the time derivative of the first state variable x₁. Optionally, the current velocity of the actuator member 3 is defined in the unit percent/second in the model 15. \dot{x}₂ is the time derivative of the second state variable x₂ and represents the current acceleration of the actuator member 3.

Expediently, the model 15, in particular the first model, comprises as a state variable, in particular as a third state variable x₃, the current first pressure p₁ of the first pressure chamber 7. p₁ is measured with the pressure sensor device 11. In particular p₁ is represented by the current signal value of the first pressure signal. \dot{x}₃ is the time derivative of the third state variable x₃ and represents the current rate of change of the first pressure p₁.

The model 15, in particular the first model, defines a relationship between the state variables x₁, x₂, x₃ and the first aeration variable u₁(t), which describes the aeration and/or deaeration of the first pressure chamber 7. Exemplarily, the first aeration variable u₁(t) is the current mass flow with which the first pressure chamber 7 is aerated and/or deaerated, for example by the automation device 1 by means of the valve device 12.

As mentioned above, the model 15, in particular the first model, comprises at least one adjustable model parameter. Exemplarily, the model 15 comprises several adjustable model parameters. Preferably, the model 15 comprises at most four, in particular exactly four, adjustable model parameters. Optionally, the model 15 comprises a maximum of five, in particular exactly five, adjustable model parameters. Via the model parameters, the relationship between the state variables x₁, x₂, x₃ and the first aeration variable u₁(t) in the model 15 is adaptable, in particular to the present variant of the pneumatic actuator 2.

Exemplarily, the model 15, in particular the first model, comprises as the model parameters, in particular as adjustable model parameters, the position term coefficient F, the spring bias travel parameter x_{F}, the first dead volume parameter V₀₁, and/or the volume change rate parameter ΔV. Preferably, the model 15, in particular the first model, comprises exclusively these four parameters as adjustable model parameters. Optionally, the model 15, in particular the first model, comprises the pressure term coefficient a as model parameter.

Preferably, the at least one model parameter comprises the position term coefficient F. Suitably, the model 15, in particular the first model, defines a relationship between the current acceleration \dot{x}₂ of the actuator member 3 and a difference between a pressure term and a product of the position term coefficient F and a position term. This is exemplified by the second equation (2). The pressure term is exemplarily p₁−pᵤ, i.e. the difference between the first pressure p₁ and the ambient pressure pᵤ. The position term is exemplary x₁−x_{F}, i.e. the difference between the current position x₁ of the actuator and the spring bias travel parameter x_{F}.

Preferably, the at least one model parameter comprises the spring bias travel parameter x_{F}. The spring bias travel parameter x_{F} represents a spring bias travel of the spring element 8 of the actuator 2. The model 15 expediently defines a relationship between the acceleration \dot{x}₂ of the actuator member 3 and a difference between the position x₁ of the actuator member 3 and the spring bias travel parameter x_{F}.

Preferably, the at least one model parameter comprises the first dead volume parameter V₀₁, which represents a first dead volume V₀₁ of the pneumatic actuator 2. The first dead volume V₀₁ is in particular the minimum volume of the first pressure chamber 7—i.e. in particular that volume of the first pressure chamber 7 which remains in that end position of the actuator member 3 in which the volume of the first pressure chamber 7 is minimum.

Preferably, the at least one model parameter comprises the volume change rate parameter ΔV. The volume change rate parameter ΔV represents a ratio of a volume change of the first pressure chamber 7 of the actuator 2 to a position change of the actuator member 3 of the actuator 2.

As already mentioned above, the pressure term coefficient a can be set to a constant value of 1 and does not represent an adjustable model parameter. Alternatively, the at least one model parameter may comprise the pressure term coefficient a.

The pressure term coefficient a is set to 1 in particular if the acceleration either cannot be measured or cannot be calculated with sufficient quality from the position signal. If the signal is available, it can be determined via equation (2) or (4). For this purpose, the system can move from one end position to the other. The equation can be evaluated in several points. Preferably, only points where the acceleration is not zero are evaluated. The result of several points can be averaged to improve the quality of the identification. Expediently, the pressure term coefficient is determined after F and x_{F} or G have been determined.

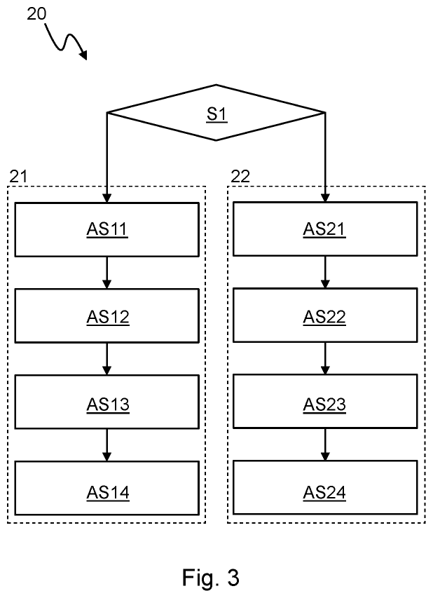

In FIG. 2, the pneumatic actuator 2 is designed as a double-acting pneumatic actuator. The above explanations relating to the pneumatic actuator 2 apply expediently in correspondence to the double-acting pneumatic actuator 2. The double-acting pneumatic actuator 2 comprises a second pressure chamber 16. The second pressure chamber 16 is delimited by the piston arrangement 4. By applying compressed air to the second pressure chamber 16, the position of the actuator member 3 can be changed. By aerating the second pressure chamber 16, the piston arrangement 4 is actuated in the direction towards the first end position. By aerating the first pressure chamber 7, the piston arrangement 4 is actuated in the direction of the second end position.

Optionally, the double-acting pneumatic actuator 2 is used in the arrangement 10 as the pneumatic actuator 2—in particular instead of the single-acting pneumatic actuator 2.

Exemplarily, the pressure sensor device 11 of the arrangement 10 further serves to detect the current pressure of the second pressure chamber 16. This current pressure of the second pressure chamber 16 shall also be referred to as the current second pressure. The pressure sensor device 11 provides a second pressure signal representing the current second pressure of the second pressure chamber 16.

Expediently, the model 15 comprises a second model, in particular designed for closed-loop controlling and/or diagnosing the double-acting pneumatic actuator 2.

Purely by way of example, the model 15, in particular the second model, defines the relationships reproduced below and described by equations (1), (4), (5) and/or (6). Preferably, the model 15 comprises the equations (1), (4), (5) and/or (6), and/or is based on the equation (1), (4), (5) and/or (6):

$${\dot{x}}_{1} = \dot{x} = {x}_{2} \qquad ( 1 )$$

$${\dot{x}}_{2} = \ddot{x} = a [ ( {p}_{1} - {p}_{u} ) - G ( {p}_{2} - {p}_{u} ) ] \qquad ( 4 )$$

$${\dot{x}}_{3} = {\dot{p}}_{1} = \frac{κ}{{V}_{01} + Δ {Vx}_{1}} ( {RTu}_{1} ( t ) - Δ {Vx}_{2} {p}_{1} ) \qquad ( 5 )$$

$${\dot{x}}_{4} = {\dot{p}}_{2} = \frac{κ}{{V}_{02} + Δ V ( 100 \% - {x}_{1} )} ( {RTu}_{2} ( t ) + Δ {Vx}_{2} {p}_{2} ) \qquad ( 6 )$$

For those quantities in equations (4), (5), and (6) that are already included in equations (1), (2), and (3) discussed above, the related explanations above apply.

p₂ is the current second pressure in the second pressure chamber 16 and has expediently the unit

$$\frac{kg}{{s}^{2} m} .$$

G is an adjustable model parameter and shall be referred to as the pressure term coefficient, in particular the second pressure term coefficient. G is preferably dimensionless.

V₀₂ is an adjustable model parameter and shall be referred to as the second dead volume parameter. The unit of V₀₂ is expediently m³.

u₂ (t) shall also be referred to as the second aeration variable and is, by way of example, the current second mass flow of compressed air into the second pressure chamber 16 or out of the second pressure chamber 16. Expediently, the automation device 1 calculates the second aeration variable on the basis of a pressure detected (in particular with the pressure sensor device 11) and/or on the basis of a control of the valve device 12.

The following explanations in particular refer to the second model.

Preferably, the model 15, in particular the second model, comprises the first state variable x₁, the second state variable x₂ the third state variable x₃, and/or a fourth state variable x₄. With respect to the first, second and third state variables, reference is made to the explanations above (set forth in particular in connection with the first model).

Expediently, the model 15, in particular the second model, comprises as a state variable, in particular as a fourth state variable x₄, the current second pressure p₂ of the second pressure chamber 16. p₂ is measured with the pressure sensor device 11. In particular p₂ is represented by the current signal value of the second pressure signal. \dot{x}₄ is the time derivative of the fourth state variable x₄ and represents the current rate of change of the second pressure p₂.

The model 15, in particular the second model, comprises at least one model parameter. Exemplarily, the model 15, in particular the second model, comprises several model parameters. Preferably, the model 15, in particular the second model, comprises a maximum of four, in particular exactly four, model parameters. Optionally, the model 15, in particular the second model, comprises a maximum of five, in particular exactly five, adjustable model parameters. Via the model parameters, in the model 15 the relationship between the state variables x₁, x₂, x₃, x₄ and the first aeration variable u₁(t) and the second aeration variable u₂(t) is adjustable, in particular to the present variant of the pneumatic actuator 2.

Exemplarily, the model 15, in particular the second model, comprises as the model parameters, in particular as adjustable model parameters, the pressure term coefficient G, the first dead volume parameter V₀₁, the second dead volume parameter V₀₂ and/or the volume change rate parameter ΔV. Preferably, the model 15, in particular the second model, comprises exclusively these four parameters as adjustable model parameters. Optionally, the model 15, in particular the first model, comprises the pressure term coefficient a as model parameter.

Preferably, the at least one model parameter comprises the pressure term coefficient G. Expediently, the model 15, in particular the second model, defines a relationship between the current acceleration \dot{x}₂ of the actuator member 3 and a difference between a first pressure term and a product of the pressure term coefficient G and a second pressure term. This is exemplified by the fourth equation (4). The first pressure term is exemplarily p₁−pᵤ, i.e. the difference between the first pressure pi and the ambient pressure pᵤ. The second pressure term is exemplary p₂−pᵤ, i.e. the difference between the second pressure p₂ and the ambient pressure pᵤ.

Preferably, the at least one model parameter comprises the second dead volume parameter V₀₂, which represents a second dead volume V₀₂ of the pneumatic actuator 2. The second dead volume V₀₂ is in particular the minimum volume of the second pressure chamber 16—i.e. in particular that volume of the second pressure chamber 16 which remains in that end position of the actuator member 3 in which the volume of the second pressure chamber 16 is minimum.

Preferably, the automation device 1 is configured to perform a parameter adjustment procedure 20 under pneumatic actuation of the pneumatic actuator 2, and to adapt, within the parameter adjustment procedure, the at least one model parameter to a present variant of the pneumatic actuator 2.

In particular, the automation device 1 is configured to adjust several or all (in particular above explained) model parameters of the model 15 to the present variant of the pneumatic actuator 2 within the parameter adjustment procedure 20.

FIG. 3 shows a flowchart of an exemplary embodiment of the parameter adjustment procedure 20.

Optionally, the parameter adjustment procedure 20 comprises a first step S1 of determining whether the present pneumatic actuator 2 is a single-acting pneumatic actuator or a double-acting pneumatic actuator. The determination is made, for example, by a user entering into the automation device 1 a functioning principle information indicating whether the present pneumatic actuator 2 is a single-acting pneumatic actuator or a double-acting pneumatic actuator. Optionally, the functioning principle information is determined via an automated process using pressure and position information. Based on the functioning principle information, the automation device 1 selectively proceeds with a first sub-procedure 21 (for a single-acting pneumatic actuator) or a second sub-procedure 22 (for a double-acting pneumatic actuator). In particular, the automation device 1 is configured to determine whether the first model or the second model is to be used for the parameter adjustment procedure 20.

The parameter adjustment procedure 20, in particular the first subprocedure 21, expediently comprises a first dead volume parameter adjustment step AS11 for adjusting the first dead volume parameter V₀₁. The automation device 1 is configured to adjust the first dead volume parameter V₀₁ by aerating and de-aerating the first pressure chamber 7 several times in succession and to measure the first pressure during this. The multiple aeration and de-aeration preferably takes place with constant mass flows. Preferably, the multiple aeration and de-aeration takes place in a state in which the actuator member 3 is in a de-aerated end position—exemplarily the first end position. Expediently, the actuator member 3 does not move during the multiple aerating and de-aerating. For example, the actuator member 3 is fixed during the multiple aerating and de-aerating, in particular in the first end position. Alternatively, movement of the actuator member 3 is prevented by performing the aerating and de-aerating in pressure ranges in which the pneumatic force is smaller than the spring force and thus no change in position occurs.

The automation device 1 is expediently configured to calculate the first dead volume parameter V₀₁ on the basis of the measured first pressure, in particular using the ideal gas equation. The automation device 1 is configured to use the calculated dead volume parameter V₀₁ in the model 15, in particular the first model.

The parameter adjustment procedure 20, in particular the first subprocedure 21, expediently comprises a position term coefficient adjustment step AS12 for adjusting the position term coefficient F. The automation device 1 is configured to, for adjusting the position term coefficient F, aerate and de-aerate the pneumatic actuator 2 so that the actuator member 3 moves between the end positions, and during this to measure a temporal course of the first pressure. The automation device 1 is further configured to, on the basis of the temporal course of the position x₁ of the actuator member 3, using the position term coefficient F, in particular using the model 15, to calculate a temporal course of the first pressure, in particular according to the following relationship (which results from equation (2)):

p₁=pᵤ+Fx₁ (7)

The automation device 1 is expediently configured to calculate an error between the measured temporal course of the first pressure and the calculated temporal course of the first pressure and to adjust the position term coefficient F (used for the calculation of the calculated temporal course of the first pressure) on the basis of the calculated error, in particular in such a way that a sum of the error during an aeration of the pneumatic actuator 2 is equal to a sum of the error during a de-aeration of the pneumatic actuator 2.

The automation device 1 is configured to use the adjusted position term coefficient F in the model 15, in particular the first model.

The parameter adjustment procedure 20, in particular the first subprocedure 21, expediently comprises a spring bias travel parameter adjustment step AS13 for adjusting the spring bias travel parameter x_{F}. The automation device 1 is configured to measure a breakaway pressure p_{L} of the pneumatic actuator 2 and, on the basis of the breakaway pressure p_{L} to calculate the spring bias travel parameter x_{F}, in particular using the (in particular already adjusted) position term coefficient F, for example according to the following relationship:

$${x}_{F} = {p}_{L} \frac{1}{F} \qquad ( 8 )$$

$${p}_{L} = {p}_{1} - {p}_{u}$$

The breakaway pressure is a pressure value of the difference of the first pressure and the ambient pressure, at which pressure value the actuator member 3 starts to move. For example, the automation device 1 is configured (in a de-aerated state of the first pressure chamber 7) to increase the first pressure and to detect that pressure value of the first pressure as a aeration breakaway pressure at which the actuator member 3 starts to move, in particular out of the first end position. Optionally, the automation device 1 is configured (in an aerated state of the first pressure chamber 7) to decrease the first pressure and to detect that pressure value of the first pressure as an de-aeration breakaway pressure at which the actuator member 3 starts to move, in particular out of the second end position.

Preferably, the automation device 1 is configured to calculate a respective spring bias travel parameter on the basis of the aeration breakaway pressure and the de-aeration breakaway pressure, in particular using equation (8), and to calculate an adjusted spring bias travel parameter on the basis of the two spring bias travel parameters calculated in this way, for example as the mean value of the two spring bias travel parameters x_{F}. The automation device 1 is configured to use the adjusted spring bias travel parameter x_{F} in the model 15, in particular the first model.

The parameter adjustment procedure 20, in particular the first subprocedure 21, expediently comprises a volume change rate parameter adjustment step AS14 for adjusting the volume change rate parameter ΔV. In particular, the automation device 1 is configured to, for adjusting the volume change rate parameter ΔV, perform a position control of the actuator member 3 according to a predetermined position trajectory, for example a ramp function or step function, and during this measure a temporal course of the position of the actuator member 3, in particular with the position sensor device 9. The automation device 1 is configured to calculate a temporal course of the position of the actuator member 3 on the basis of the model 15, in particular using inverted model equations of the model 15. The automation device 1 is configured to adjust the volume change rate parameter ΔV on the basis of the measured temporal course and the calculated temporal course, in particular in such a way that an error, in particular a summed difference, between the measured temporal course and the calculated temporal course is minimal. The automation device 1 is configured to use the adjusted volume change rate parameter ΔV in the model 15, in particular the first model.

The second subprocedure 22 will be discussed below.

The parameter adjustment procedure 20, in particular the second subprocedure 22, expediently comprises a first dead volume parameter adjustment step AS21 for adjusting the first dead volume parameter V₀₁. The first dead volume parameter adjustment step AS21 is expediently the same as the first dead volume parameter adjustment step AS11 explained above, so that the explanations in this respect also apply to the first dead volume parameter adjustment step AS21. The automation device 1 is configured to adjust the calculated dead volume parameter V₀₁ in the model 15, in particular the second model.

The parameter adjustment procedure 20, in particular the second subprocedure 22, expediently comprises a second dead volume parameter adjustment step AS22 for adjusting the second dead volume parameter V₀₂. The automation device 1 is configured to, for adjusting the second dead volume parameter V₀₂, aerate and de-aerate the second pressure chamber 16 several times in succession and to measure the second pressure during this. The multiple aeration and de-aeration preferably takes place with constant mass flows. Preferably, the multiple aeration and de-aeration takes place in a state in which the actuator member 3 is in a de-aerated end position—exemplarily the second end position. Expediently, the actuator member 3 does not move during the multiple aerating and de-aerating. For example, the actuator member 3 is fixed during the multiple aerating and de-aerating, in particular in the second end position. Alternatively, the actuator member 3 is held in the end position by aerating the pressure chambers 7, 16 in such a way that the second pressure chamber 16 always causes a greater force than the first pressure chamber 7.

The automation device 1 is expediently configured to calculate the second dead volume parameter V₀₂ on the basis of the measured second pressure, in particular using the ideal gas equation. The automation device 1 is configured to use the calculated dead volume parameter V₀₂ in the model 15, in particular the second model.

The parameter adjustment procedure 20, in particular the second subprocedure 22, expediently comprises a pressure term coefficient adjustment step AS23 for adjusting the pressure term coefficient G. The automation device 1 is configured to, for adjusting the pressure term coefficient G, aerate and de-aerate the pneumatic actuator 2 so that the actuator member 3 moves between the end positions, and, during this, to measure a temporal course of the first pressure. The automation device 1 is further configured to calculate, on the basis of the temporal course of the second pressure p₂ of the actuator member 3 using the pressure term coefficient G (for example an initial value of the pressure term coefficient), in particular using the model 15, a temporal course of the first pressure, in particular according to the following relationship (which results from equation (4)):

p₁=G(pᵤ−p₂)+pᵤ (9)

The automation device 1 is expediently configured to calculate an error between the measured temporal course of the first pressure and the calculated temporal course of the first pressure and to adjust the position term coefficient G (used for the calculation of the calculated temporal course of the first pressure) on the basis of the calculated error, in particular in such a way that a sum of the error during a aeration of the pneumatic actuator 2 is equal to a sum of the error during a de-aeration of the pneumatic actuator 2. The automation device 1 is configured to use the adjusted pressure term coefficient G in the model 15, in particular the second model.

The parameter adjustment procedure 20, in particular the second subprocedure 22, expediently comprises a volume change rate parameter adjustment step AS24 for adjusting the volume change rate parameter ΔV. The volume change rate parameter adjustment step AS24 is expediently the same as the volume change rate parameter adjustment step AS14 explained above, so that the explanations in this respect also apply to the volume change rate parameter adjustment step AS24. The automation device 1 is configured to adjust the calculated volume change rate parameter ΔV in the model 15, in particular the second model.

The automation device 1 is configured to perform a closed-loop control and/or diagnosis of the pneumatic actuator 2 using the model 15, in particular using the first model and/or the second model. The closed-loop control is a model-based closed-loop control and/or the diagnosis is a model-based diagnosis.

The closed-loop control is, for example, a position closed-loop control of the actuator member 3. Furthermore, the closed-loop control may comprise a closed-loop pressure control and/or a closed-loop stiffness control. Expediently, the automation device 1 is configured to calculate, using the model 15, in particular the first model and/or the second model, one or more actuating signals for controlling the valve device 12, in particular on the basis of a setpoint value and/or an actual value, in order to perform the closed-loop control, in particular the closed-loop position control.

Furthermore, the closed-loop control can be a multivariable closed-loop control. The model also allows multivariable closed-loop control (especially for double-acting actuators). Preferably, the position and the pressure level are closed-loop controlled independently. In addition to closed-loop position control, this also allows closed-loop control of stiffness or energy optimization, for example.

When performing the diagnosis, the automation device 1 expediently generates a diagnosis information. The diagnosis information comprises, for example, fault information indicating a fault of the pneumatic actuator 2 and/or wear information indicating wear of the pneumatic actuator 2. Expediently, the automation device 1 calculates the diagnosis information using the model 15, in particular the first model and/or the second model, on the basis of one or more actuating signals calculated in the context of a closed-loop control, in particular the closed-loop control explained above, and/or a setpoint value and/or an actual value.

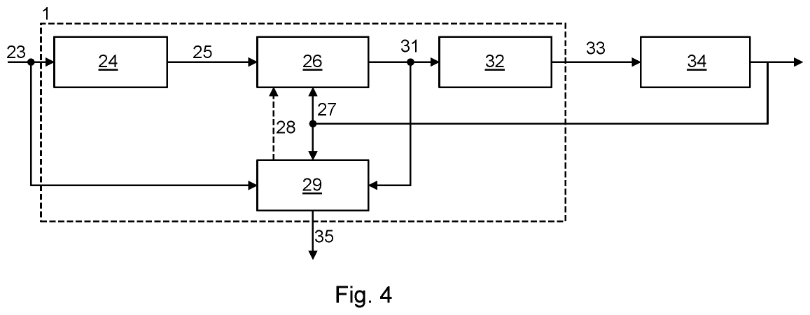

FIG. 4 shows a block diagram of a closed-loop control and/or diagnosis performed with the automation device 1.

A setpoint 23 is fed to the automation device 1. The setpoint 23 is exemplarily a setpoint for the position of the actuator member 3.

Optionally, the automation device 1 is configured to perform trajectory planning 24 based on the setpoint 23 to calculate a trajectory setpoint 25.

Preferably, the automation device 1 is designed to perform a model-based closed-loop control 26 using the model 15, in particular the first model and/or the second model, in particular on the basis of the trajectory setpoint 25 or (if the trajectory planning 24 is not available) on the basis of the setpoint 23, as well as on the basis of an actual value 27 and optionally taking into account error information 28 from a model-based diagnosis 29. The actual value 27 is, by way of example, an actual value for the position of the actuator member 3. The automation device 1 calculates, as part of the model-based closed-loop control 26, one or more actuating signals 31 for controlling a pneumatic actuating system 32. The pneumatic actuating system 32 is, for example, the valve device 12.

The pneumatic actuating system 32 outputs one or more mass flows 33 to a pneumatic drive system 34 according to the one or more actuating signals 31. The pneumatic drive system 34 is, for example, the pneumatic actuator 2.

The actual value 27 of the pneumatic drive system 34—for example the current position of the actuator member 3—is detected and fed to the model-based closed-loop control 26 and/or the model-based diagnosis.

Preferably, the automation device 1 is configured to perform a model-based diagnosis using the model 15, in particular the first model and/or the second model, in particular on the basis of the setpoint 23 and/or the one or more actuating signals 31 and/or the actual value 27. In particular, the automation device 1 is configured to generate the error information 28 as part of the model-based diagnosis. The automation device 1 is expediently configured to generate the diagnosis information 35 within the model-based diagnosis and expediently to output it to a user.

In particular, the automation device 1 can be operated according to a method comprising the step of: performing the closed-loop control and/or diagnosis of the pneumatic actuator 2 using the model 15. Preferably, the method further comprises the step (performed in particular before the step of performing the closed-loop control and/or diagnosis) of: performing the parameter adjustment procedure, and within the parameter adjustment procedure, adjusting the at least one model parameter to a present variant of the pneumatic actuator 2. Preferably, within the parameter adjustment procedure, several model parameters, in particular the aforementioned model parameters, for example exactly four model parameters, are adjusted to the present variant of the pneumatic actuator 2.

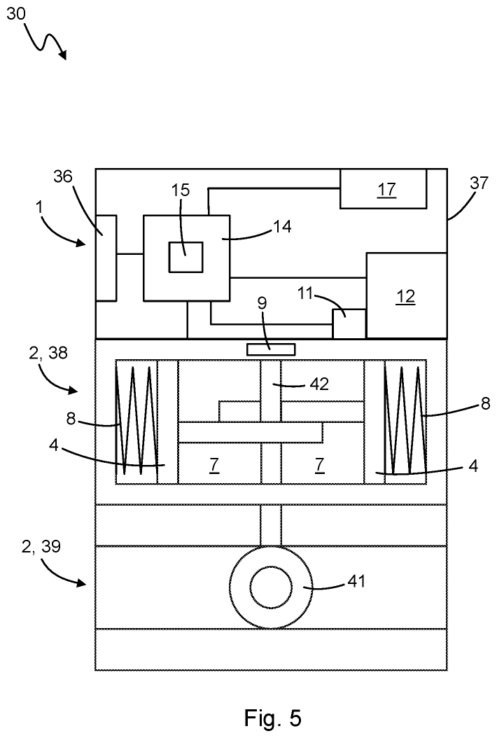

FIG. 5 shows a process valve assembly 30. The process valve assembly 30 is an exemplary embodiment of the arrangement 10. The process valve assembly 30 comprises the automation device 1, and the pneumatic actuator 2. The pneumatic actuator 2 is designed as a process valve.

The automation device 1 is exemplarily designed as a positioner. The automation device 1 comprises a housing 37, in which the valve device 12, the control unit 14 and/or the pressure sensor device 11 are expediently arranged. Exemplarily, the input unit 17 and/or the communication interface 36 are arranged in and/or on the housing 37.

The automation device 1 (in particular designed as a positioner) is exemplarily attached to the pneumatic actuator 2, in particular with its housing 37.

The pneumatic actuator 2 (exemplarily designed as a process valve) comprises an drive 38 and a fitting 39 which can be actuated by the drive. The fitting 39 comprises a valve member 41 which is actuated by the drive 38.

The drive 38 is designed as a rotary drive, for example. The drive 38 comprises the piston arrangement 4. The drive 38 has the first pressure chamber 7. The first pressure chamber 7 is delimited by the piston arrangement 4. Exemplarily, the drive 38 is of single-acting design. Exemplarily, the drive 38 comprises the spring element 8, which provides the spring force acting on the piston arrangement 4.

The drive 38 has a drive element 42 that can be driven via the piston arrangement 4. The drive element 42 is coupled to the valve member 41 so that the position of the valve member 41 can be changed via the drive element 42.

Expediently, the piston arrangement 4, the drive element 42 or the valve member 41 represents the actuator member 3.

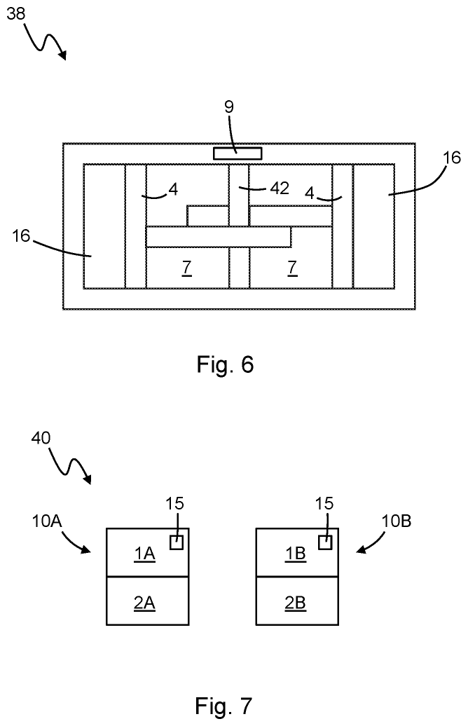

FIG. 6 shows an alternative design of the drive 38. Here, the drive 38 is double-acting. The drive 38 comprises (in addition to the first pressure chamber 7) the second pressure chamber 16. The second pressure chamber 16 is delimited by the piston arrangement 4.

Optionally, the drive 38 used in the process valve assembly 30 is the double-acting drive 38—in particular, instead of the single-acting drive 38.

When using the single-acting drive 38, the automation device 1 uses the first model for closed-loop control and/or diagnostics. When using the double-acting drive 38, the automation device 1 uses the second model for closed-loop control and/or diagnostics.

FIG. 7 shows a system 40 comprising a plurality of arrangements 10A, 10B, each comprising a respective automation device 1A, 1B and a respective pneumatic actuator 2A, 2B associated with the respective automation device 1A, 1B. Each automation device 1A, 1B is designed like an automation device 1 explained above. Each pneumatic actuator 2A, 2B is designed like a pneumatic actuator 2 explained above. Exemplarily, the system 40 comprises a first arrangement 10A comprising a first automation device 1A and a first pneumatic actuator 2A associated with the first automation device 1A. Exemplarily, the system 40 comprises a second arrangement 10B comprising a second automation device 1B and a second pneumatic actuator 2B associated with the second automation device 1B.

Optionally, more than two arrangements may be present. For example, there may be more than 5, more than 10, or more than 20 arrangements.

Each automation device 1A, 1B has a respective model 15 for performing diagnosis and/or closed-loop control of the respective associated pneumatic actuator 2A, 2B. Each model 15 is expediently designed as the model 15 explained above and expediently comprises the first model and/or the second model.

Preferably, the models 15 of the automation devices 1A, 1B do not differ from each other. In particular, each automation device 1A, 1B has the same model 15, especially the same first model and/or the same second model.

Preferably, two of the pneumatic actuators 2A, 2B differ from each other in their variant. For example, the first pneumatic actuator 2A is designed according to a first variant and or the second pneumatic actuator 2B is designed according to a second variant different from the first variant. The first variant and the second variant can differ, for example, as already explained at the beginning, in their kinematics, dimensioning and/or their load.

Preferably, the system 40 is operated by a method comprising the step of: adjusting at least one model parameter of each model 15 to adapt the respective model 15 to a present variant of the respective associated pneumatic actuator 2A, 2B. Exemplarily, the model 15 of the first automation device 1A is adjusted to the present first variant of the first pneumatic actuator 2A, in particular by adjusting at least one, preferably several, exemplarily exactly four, model parameters of the model 15, for example by carrying out the parameter adjustment procedure explained above with the first arrangement 10A.

Exemplarily, the model 15 of the second automation device 1B is adjusted to the present second variant of the second pneumatic actuator 2B, in particular by adjusting at least one, preferably several, exemplarily exactly four, model parameters of the model 15, for example by carrying out the parameter adjustment procedure explained above with the second arrangement 10B.

For example, the pneumatic actuators 2A, 2B are designed as single-acting pneumatic actuators. For example, the first automation device 1A and the second automation device 1B each comprise the first model. In the first model of the first automation device 1A, the position term coefficient F, the spring bias travel parameter x_{F}, the first dead volume parameter V₀₁, and/or the volume change rate parameter ΔV (and expediently no other parameter) are adjusted to the present first variant of the first pneumatic actuator 2A. In the first model of the second automation device 1B, the position term coefficient F, the spring bias travel parameter x_{F}, the first dead volume parameter V₀₁, and/or the volume change rate parameter ΔV (and expediently no further parameter) are adjusted to the present second variant of the second pneumatic actuator 2A.

For example, the pneumatic actuators 2A, 2B are designed as double-acting pneumatic actuators. For example, the first automation device 1A and the second automation device 1B each comprise the second model. In the second model of the first automation device 1A, the pressure term coefficient G, the first dead volume parameter V₀₁, the second dead volume parameter V₀₂, and/or the volume change rate parameter ΔV (and expediently no further parameter) are adjusted to the present first variant of the first pneumatic actuator 2A. In the second model of the second automation device 1B, the pressure term coefficient G, the first dead volume parameter V₀₁, the second dead volume parameter V₀₂, and/or the volume change rate parameter ΔV (and expediently no further parameter) are adjusted to the present second variant of the second pneumatic actuator 2B.

1. An automation device for industrial automation, for closed-loop controlling and/or diagnosing a pneumatic actuator having an actuator member, the automation device having a model of the pneumatic actuator, which model has at least one model parameter via which the model can be adapted to different variants of the pneumatic actuator, and wherein the automation device is configured to carry out closed-loop control and/or diagnosis of the pneumatic actuator using the model.

2. The automation device according to claim 1, wherein the model is a nonlinear model.

3. The automation device according to claim 1, wherein the automation device is configured to perform a parameter adjustment procedure with a pneumatic actuation of the pneumatic actuator, and to adjust, within the parameter adjustment procedure, the at least one model parameter to a present variant of the pneumatic actuator.

4. The automation device according to claim 1, wherein the model comprises, as a state variable, a current position of the actuator member, wherein the current position is defined as a relative quantity in the model.

5. The automation device according to claim 1, wherein the at least one model parameter comprises a position term coefficient, and the model defines a relationship between a current acceleration of the actuator member and a difference of a pressure term and a product of the position term coefficient and a position term.

6. The automation device according to claim 1, wherein the at least one model parameter comprises a spring bias travel parameter representing a spring bias travel of a spring element of the pneumatic actuator, wherein the model defines a relationship between an acceleration of the actuator member and a difference of a position of the actuator member and the spring bias travel parameter.

7. The automation device according to claim 1, wherein the at least one model parameter comprises a dead volume parameter representing a dead volume of the pneumatic actuator.

8. The automation device according to a claim 1, wherein the at least one model parameter comprises a volume change rate parameter representing a ratio of a volume change of a first pressure chamber of the actuator to a position change of the actuator member.

9. The automation device according to claim 1, wherein the at least one model parameter comprises a pressure term coefficient, and the model defines a relationship between an acceleration of the actuator member and a difference of a first pressure term and a product of the pressure term coefficient and a second pressure term.

10. A process valve assembly, comprising an automation device according to claim 1, and the pneumatic actuator, wherein the pneumatic actuator is designed as a process valve.

11. A method of operating an automation device according to claim 1, comprising the step of: performing closed-loop control and/or diagnostics of the pneumatic actuator using the model.

12. The method of claim 11, further comprising the step of: performing a parameter adjustment procedure, and within the parameter adjustment procedure, adjusting the at least one model parameter to a present variant of the pneumatic actuator.

13. A method of operating a system comprising a plurality of arrangements which each comprise a respective automation device and a respective pneumatic actuator associated with the respective automation device, wherein each automation device is implemented according to the automation device of claim 1 and has a respective model, for performing diagnosis and/or closed-loop control of the respective associated pneumatic actuator, wherein the models of the automation devices do not differ from each other, and wherein at least two of the pneumatic actuators differ from each other in their variant, the method comprising the step of: adjusting at least one model parameter of each model in order to adapt the respective model to a present variant of the respectively associated pneumatic actuator.
